(19) United States
(12) Patent Application Publication
(10) Pub. No.: US 2023/0376968 A1
(43) Pub. Date: Nov. 23, 2023

(54) DIGITAL ENROLLMENT SYSTEMS AND METHODS

(71) Applicant: FMR LLC, Boston, MA (US)

(72) Inventors: Harmeet Singh, Boston, MA (US); Michael Eggerl, Boston, MA (US); Jia You, Boston, MA (US); Abhishek Kumar, Boston, MA (US); Brian Towne, Boston, MA (US)

(21) Appl. No.: 17/746,225

(22) Filed: May 17, 2022

(51) Int. Cl. G06Q 30/00; G06F 16/435

(52) U.S. Cl. CPC G06Q 30/016; G06F 16/435

(57) ABSTRACT

A computerized method is provided for responding to a request by a customer to enroll into a digital service. The method includes generating a personalized media clip for presentation to the enrolling customer, which comprises (i) using an artificial intelligence (AI) model to determine a plurality of relevant media objects based on data related to the request and customer data and (ii) forming a randomized composite of the plurality of relevant media objects. The method also includes providing the personalized media clip along with an instruction to the customer to record an audio description of the media clip. The method further includes generating a confidence score that measures a degree of accuracy of the audio description by the customer in relation to the personalized media clip, where enrollment of the customer into the digital service is based on at least the confidence score.

### TECHNICAL FIELD

This application relates generally to systems, methods and apparatuses, including computer program products, for responding to a request by a customer to enroll in a digital service.

### BACKGROUND

Traditionally, service enrollment of a customer based on voice biometrics is accomplished with a live associate over a telephony communication channel. This form of communication promotes customer thinking voice in order to capture the full color of the customer's utterance, as the thinking voice typically includes hesitation, confirmation, clarity of thoughts, etc. In contrast, service enrollment based on voice biometrics in the digital space/platform is limited to presenting the customer with a predefined one-size-fits-all script so that the customer can read out loud using his/her readout voice, which differs greatly from the thinking voice. Therefore, systems and methods are needed to introduce thinking voice capability in the digital space for facilitating customer enrollment to digital services based on voice biometrics.

### SUMMARY

To remedy the above shortcomings in today's market, the present invention provides systems and methods for customer digital enrollment using artificial intelligence (AI) algorithms to invoke a customer's thinking voice without human (e.g., live agent) intervention. In some embodiments, the AI algorithms are used to understand the customer, based on which one or more visuals are selected during runtime to invoke the customer's thinking voice. In some embodiments, the customer's thinking voice is converted to text and analyzed for indicators confirming the thinking voice as well as validating the customer for the purpose of fraud detection. The present invention can be used for digital enrollment to and/or digital procurement of a variety of services such as branch visit, account opening, proactive engagement over the Internet and proactive engagement on mobile devices.

In one aspect, the present application features a computerized method for responding to a request by a customer to enroll into a digital service. The computerized method includes generating, by a computing device, a personalized media clip for presentation to the enrolling customer. Generating the personalized media clip comprises (i) using an artificial intelligence (AI) model to determine a plurality of relevant media objects based on data related to the request and customer data and (ii) forming a randomized composite of the plurality of relevant media objects. The method also includes providing, by the computing device, the personalized media clip along with an instruction to the customer to record an audio description of the personalized media clip and generating, by the computing device, a confidence score that measures a degree of accuracy of the audio description by the customer in relation to the personalized media clip. The confidence score comprises a weighted sum of a plurality of matching scores including (i) a static matching score generated by comparing a text representation of the audio description with a list of one or more predefined keywords, and (ii) an AI score generated by determining whether the text representation describes the randomized composite of the relevant media objects in the personalized media clip. The method further comprises enrolling, by the computing device, the customer into the digital service based on at least the confidence score.

In another aspect, the invention features a computerized means for responding to a request by a customer to enroll into a digital service. The computerized means comprises means for generating a personalized media clip for presentation to the enrolling customer including (i) means for generating and training an artificial intelligence (AI) model to determine a plurality of relevant media objects based on data related to the request and customer data and (ii) means for forming a randomized composite of the plurality of relevant media objects. The computerized means also includes means for providing the personalized media clip along with an instruction to the customer to record an audio description of the personalized media clip and means for generating a confidence score that measures a degree of accuracy of the audio description by the customer in relation to the personalized media clip. The confidence score comprises a weighted sum of a plurality of matching scores including (i) a static matching score generated by comparing a text representation of the audio description with a list of one or more predefined keywords, and (ii) an AI score generated by determining whether the text representation describes the randomized composite of the relevant media objects in the personalized media clip. The computerized means further includes means for enrolling the customer into the digital service based on at least the confidence score.

Any of the above aspects can include one or more of the following features. In some embodiments, each of the plurality of relevant media objects comprises one of a visual image or an audio segment. In some embodiments, the AI model is trained to model relationships between historical request contexts and media objects.

In some embodiments, the data related to the request and the customer data includes one or more of customer demographics information, customer browsing history and interaction history from similar customers.

In some embodiments, the personalized media clip comprises a video segment of a randomized composite of images selected by the AI model. In some embodiments, the randomized composite is formed at runtime as the personalized media clip is presented to the customer.

In some embodiments, the instruction further includes interactive requests asking the customer for one or more physical inputs. The one or more physical inputs can include face capture, expression capture, body movements, or click or drag a visual item.

In some embodiments, the text representation of the audio description is processed before generating the plurality of matching scores. Processing the text representation comprises one or more of tokening the text representation and removing one or more stop words from the text representation.

In some embodiments, the plurality of matching scores further includes a fraud score generated based on fraud analytics of the customer. In some embodiments, the plurality of matching scores further includes a score indicating if the customer is a part of a digital enrollment guest list for the digital service. In some embodiments, the plurality of matching scores further includes a dynamic matching score generated by computing and allocating weights to words in the text representation of the audio description.

In some embodiments, enrolling the customer based on at least the confidence score comprises comparing the confidence score with a predefined confidence level, confirming that a biometric signal associated with the customer matches the customer's biometric print, and allowing customer enrollment if at least one of the confidence score exceeds the predefined confidence level and the biometric signal matches. In some embodiments, the customer is presented with a new personalized media clip if the confidence score is below the predefined confidence level but above a lower confidence threshold indicating a borderline case.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a digital enrollment engine used in a computing system for digitally enrolling a customer by invoking the customer's thinking voice, according to some embodiments of the present invention.

FIG. 2 shows a process diagram of an exemplary computerized method for digitally enrolling a customer by invoking the customer's thinking voice utilizing the computing system and resources of FIG. 1, according to some embodiments of the present invention.

FIGS. 3a-c show a series of exemplary user interfaces for capturing an enrolling customer's thinking voice based on an exemplary personalize media clip displayed to the customer, according to some embodiments of the present invention.

FIG. 4 shows an exemplary decision process employed by the digital enrollment engine of FIG. 1 to determine whether to enroll a customer, according to some embodiments of the present invention.

FIG. 5 shows an exemplary data structure of the hybrid artificial intelligence algorithm used by the digital enrollment engine of FIG. 1, according to some embodiments of the present invention.

### DETAILED DESCRIPTION

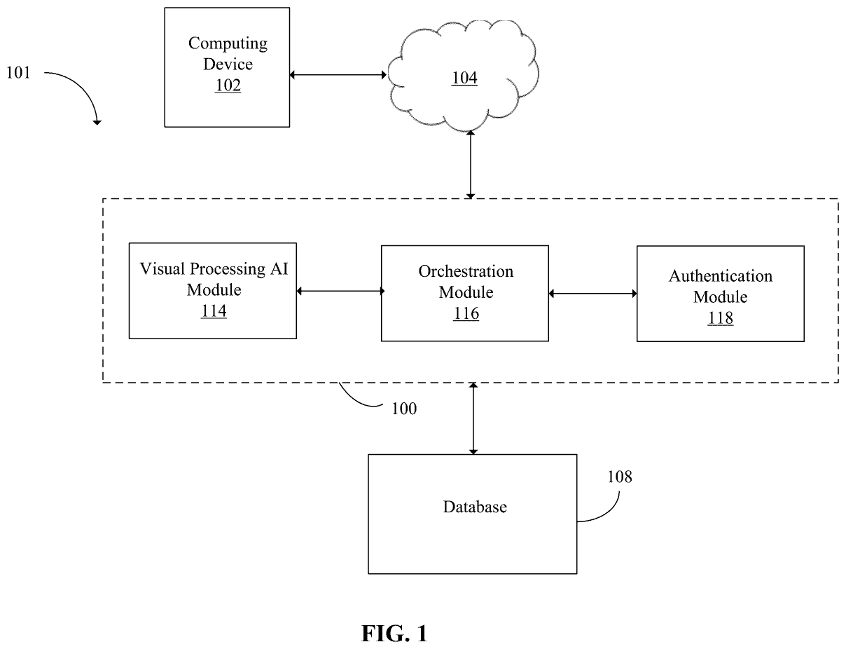

FIG. 1 shows an exemplary diagram of a digital enrollment engine 100 used in a computing system 101 for digitally enrolling a customer by invoking the customer's thinking voice, according to some embodiments of the present invention. As shown, the computing system 101 generally includes at least one client computing device 102, a communication network 104, the digital enrollment engine 100, and one or more databases 108.

The client computing device 102 connects to the communication network 104 to communicate with the digital enrollment engine 100 and/or the database 108 to provide inputs and receive outputs relating to the process of vocally signing a digital document as described herein. For example, the computing device 102 can provide a detailed graphical user interface (GUI) that allows a user to input enrollment request data and voice samples and display instructions and results using the analysis methods and systems described herein. Exemplary computing devices 102 include, but are not limited to, telephones, desktop computers, laptop computers, tablets, mobile devices, smartphones, and internet appliances. In some embodiments, the computing device 102 has voice playback and recording capabilities. It should be appreciated that other types of computing devices that are capable of connecting to the components of the computing system 101 can be used without departing from the scope of invention. Although FIG. 1 depicts a single computing device 102, it should be appreciated that the computing system 101 can include any number of client devices.

The communication network 104 enables components of the computing system 101 to communicate with each other to perform the process of enrollment of customers to digital services. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The digital enrollment engine 100 is a combination of hardware, including one or more processors and one or more physical memory modules and specialized software engines that execute on the processor of the digital enrollment engine 100, to receive data from other components of the computing system 101, transmit data to other components of the computing system 101, and perform functions as described herein. As shown, the processor of the digital enrollment engine 100 executes a visual processing AI module 114, an orchestration module 116, and an authentication module 118. These sub-components and their functionalities are described below in detail. In some embodiments, the various components of the digital enrollment engine 100 are specialized sets of computer software instructions programmed onto a dedicated processor in the digital enrollment engine 100 and can include specifically-designated memory locations and/or registers for executing the specialized computer software instructions.

The database 108 is a computing device (or in some embodiments, a set of computing devices) that is coupled to and in communication with the digital enrollment engine 100 and is configured to provide, receive and store various types of data received and/or created for performing voice signature of digital documents, as described below in detail. In some embodiments, all or a portion of the database 108 is integrated with the digital enrollment engine 100 or located on a separate computing device or devices. For example, the database 108 can comprise one or more databases, such as MySQL™ available from Oracle Corp. of Redwood City, California.

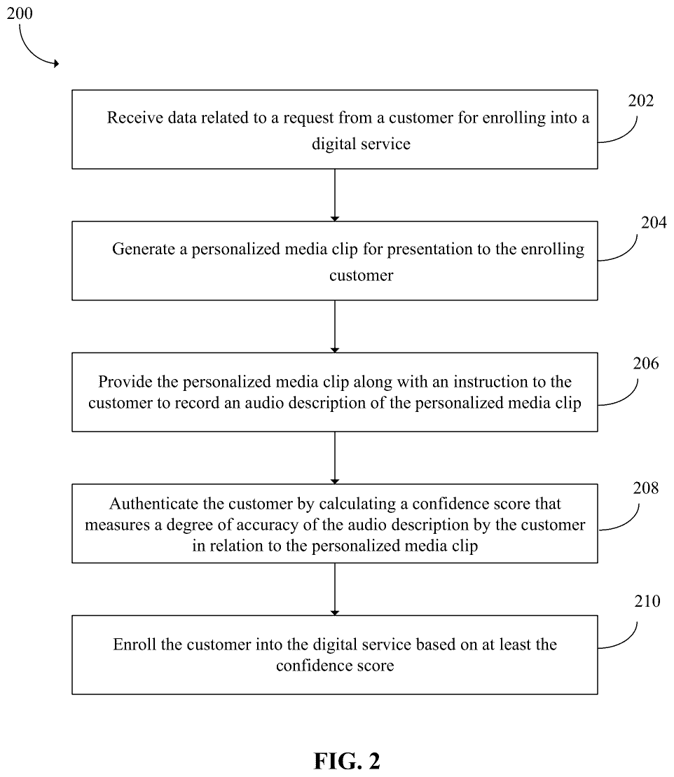

FIG. 2 shows a process diagram of an exemplary computerized method 200 for digitally enrolling a customer by invoking the customer's thinking voice utilizing the computing system 101 and resources of FIG. 1, according to some embodiments of the present invention. The method 200 starts with the orchestration module 116 of the digital enrollment engine 100 receiving data related to a request to enroll into a digital service made from a customer via the customer's computing device 102 (step 202). For example, the customer can supply the request and related data from a web-based user interface generated by the orchestration module 114 and displayed on the customer's computing device 102. In some embodiments, the web-based user interface is initiated by the customer via a vendor website to start the desired enrollment request. In some embodiment, the orchestration module 116 can collect pertinent contextual data related to the enrolling customer, such as customer digital footprint and metadata, demographic data, historical transactional trending data, relationship lifetime data, prediction related to the individual customer and current capability usage from other customers, fraud analysis, market analysis, and/or relationship with third party institutions.

Upon receiving the customer request and related contextual information, the orchestration module 116 is configured to interact with the visual processing AI module 114 to generate a personalized media clip for presentation to the enrolling customer (step 204). The visual processing AI module 114 can generate the personalized media clip by (i) first using a trained artificial intelligence (AI) model to determine one or more media objects relevant to the enrolling customer and (ii) forming a randomized composite of the relevant media objects in the media clip that is personalized to the enrolling customer. In some embodiments, the visual processing AI module 114 trains the AI model to predict relationships between request contexts and media objects. Thus, the trained AI model is configured to generate media objects relevant to a particular enrollment request. In some embodiments, a media object is a visual image or an audio segment.

In some embodiments, the visual processing AI module 114 uses a hybrid Neural Collaborative Filter algorithm to train the AI model. In some embodiments, the data used to train the AI model includes previously-collected relationship data between customer request contexts and relevant media objects. For example, the training data can comprise at least one of demographics information related to past customers (e.g., existing customer profile data), data related to customer actions across multiple interaction channels (e.g., customer browsing history on other platforms), interaction history data, and device-based feedback such as click stream, live customer interaction, proactive surveys, feedback loop etc. The training data can also include compressive analysis of customers belonging to similar social economic background. In some embodiments, the training data includes recent national/international news that can be utilized to present a relevant theme to the customer for more interactive experience. In some embodiments, the trained model is periodically evaluated, updated and re-trained to take into consideration of more current training data, such as most recent customer data and interaction history data. The resulting trained AI model can be stored in the database 108 for easy access and retrieval.

In some embodiments, the AI algorithm is implemented in a recommendation system as a hybrid neural collaborative filtering (CF) algorithm. The recommendation system is configured to return a composite visual presentation that is adapted to engage the customer and capture the full color of their thinking voice with no human intervention. This hybrid algorithm combines two or more recommendation strategies in different ways to benefit from their complementary advantages. The hybrid algorithm not only considers user's historical behavior information, but also take into account of the user's context information described above, such as demographics, behavior of customer with similar profile, trust relationships, friend relationships, user tags, time information, location, etc. For example, the training data used in conjunction with the hybrid algorithm can include one or more of visual composites that have been used during previous digital enrollments sessions, spontaneous visual add-ons, NLP that identifies what user has identified and mentioned, customer demographics, behavior of customers with similar profile, trust relationships, friend relationships, user tags, item attributes, time information, location, click stream information, customer phone call records, etc.

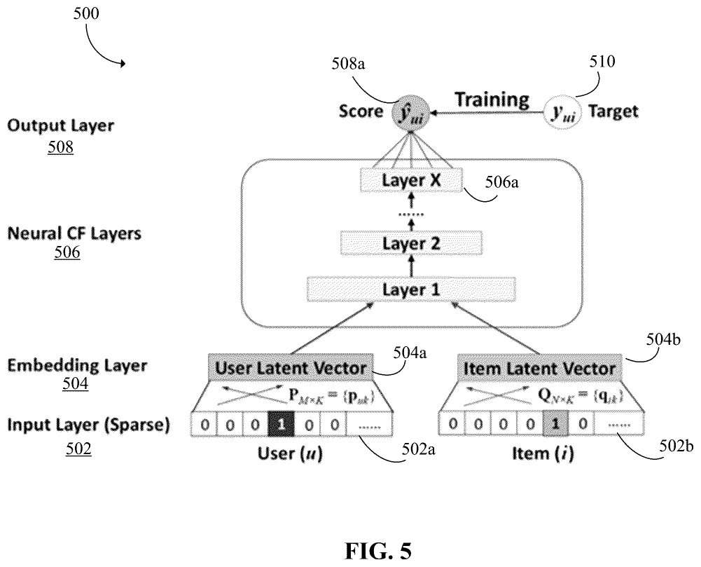

In some embodiments, the hybrid algorithm integrates various latent factor models with various users' social relationships, and the results indicate that data dimensions are reduced, recommendation accuracy is improved, and scalability of the recommendation system is enhanced based on these models. FIG. 5 shows an exemplary data structure 500 of the hybrid artificial intelligence algorithm used by the digital enrollment engine 100 of FIG. 1, according to some embodiments of the present invention. As shown, the exemplary data structure 500 can include an input layer 502, an embedding layer 504, one or more neural CF layers 506 and an output layer 508, where the output of one layer serves as the input of the next one. The input layer 502 can include two feature vectors 502a, 502b describing user u and item i, respectively. These feature vectors 502a, 502b are customizable to support a wide range of modeling of users and items and are context-aware, content-based, and neighbor-based, for example. Above the input layer 502 is the embedding layer 504, which is a connected layer that projects each sparse representation in the input layer (i.e., feature vectors 502a, 502b) to a dense vector. In the context of latent factor model, the resulting user embedding can be represented as a user latent vector 504a and the resulting item embedding can be represented as an item latent vector 504b. The user embedding and item embedding 504a, 504b are then fed into a multi-layer neural architecture, i.e. the one or more neural CF layers 506, to map the latent vectors 504a, 504b to prediction scores. Each layer of the neural CF layers 506 can be customized to discover certain latent structures of user-item interactions. In some embodiments, the neural CF layers 506 includes at least one hidden layer X 506a, the dimension of which determines the model's capability. The output layer 508 produces a predicted score (508a). In some embodiments, model training can be performed with the goal of minimizing the pointwise loss between the predicted score 508a and its target value Yui (510). Thus, the predicted score can be formulated as the following equation:

ŷᵤᵢ=f(P^{T}vᵤ^{U},Q^{T}vᵢ^{I}|P,Q,Θⱼ),

where P∈R^{m*k} and Q∈R^{n*k}, denoting the latent factor matrix for users and items, respectively; and Θ_{f} denotes the model parameters of the interaction function f. Since the function f is defined as a multi-layer neural network, it can be formulated as:

f(P^{T}vᵤ^{U},Q^{T}vᵢ^{I})=ϕₒᵤₜ(ϕ_{X}( . . . ϕ₂(ϕ₁(P^{T}vᵤ^{U},Q^{T}vᵢ^{I})) . . . )),

where Θout and Θx respectively denote the mapping function for the output layer and x-th neural collaborative filtering (CF) layer, and there are X neural CF layers in total.

After AI model training, the visual processing AI module 114 can supply contextual data related to the enrolling customer (collected from step 202) as inputs to the trained AI model to determine a set of one or more relevant media objects (e.g., visual images and/or audio segments). Based on the relevant media objects obtained, the visual processing AI module 114 can form a personalized media clip comprising a randomized composite of the multiple relevant media objects and present the personalized media clip to the enrolling customer via a user interface to invoke the customer's thinking voice for the purpose of enrollment/authentication (step 206). In some embodiments, the randomization is performed at runtime as the media clip is presented to the customer. As an example, the personalized media clip can be a video segment of a randomized, ad-hoc composite of images selected by the trained AI model. In some embodiments, the user interface additionally provides written instructions to the enrolling customer to record an audio description of the media clip as the media clip is being played to the customer. In some embodiments, in addition to such audio recording, the digital enrollment engine can instruct the enrolling customer to supply other interactive inputs, such as one or more physical inputs, for the purpose of authenticating the customer. Exemplary physical inputs include one or more of face capture, expression capture, specific body movements, and/or click or drag a visual item. In some embodiments, the enrollment process, including feedback/inputs received from the customer, takes place within an augmented reality (AR) or virtual reality (VR) environment. An AR model can utilize a real-world setting while placing objects, images and/or video(s) within the customer's environment for requested descriptions. A VR model can utilize a virtual reality environment while placing objects, images and/or video(s) within the customer's environment for requested descriptions. Exemplary customer feedback within an AR or VR environment includes a hint/nudge, such as a touch, vibration, gesture (e.g., via a device that can capture gestures by finger movement), and/or user mode (e.g., sitting versus standing).

In some embodiments, the visual processing AI module 114 is configured to also generate a pool of words describing the personalized media clip. First, each select media object can be associated with a set of pre-defined static descriptive keywords prior to runtime, thereby forming a pool of pre-defined static keywords associated with the media clip. At runtime, the visual processing AI module 114 can determine a randomized order to play these select media objects (i.e., a randomized composite of the media objects) and generate a set of dynamic keywords associated with the personalized media clip. These dynamic keywords can be generated/extracted from a master description of the media clip. Additional words similar to the words in the master description can be determined and added to the pool of dynamic keywords. Further, over time as the media objects in the media clip are displayed to other users in other media clips, user-supplied description of the media objects can be saved as keywords to the pool of dynamic keywords. For example, dynamic keywords can be generated by analyzing previous customer responses to the given media object and identifying frequent commonalities. These commonalities can be selected keywords based on frequency, which can be added to the pool of dynamic keywords improving the AI model. Commonalities can also be between similar customer backgrounds (e.g., age, sex, location, depth and correlations with respect to virtual reality capabilities, etc.) to determine if similar backgrounds yield more commonalities in descriptions. As an example, there are different vocabulary between younger and older customers, which would influence selection of dynamic keywords personalized to the customer's background. Commonalities can further be considered based on depth of field, distance and proximity within an augmented reality (AR) or virtual reality (VR) experience. In some embodiments, determination of these dynamic keywords is accomplished during run time as the personalized media clip is dynamically assembled and played to the enrolling customer. In some embodiments, the personalized media clip, along with its corresponding pools of static and dynamic descriptive keywords, is saved in the database 108.

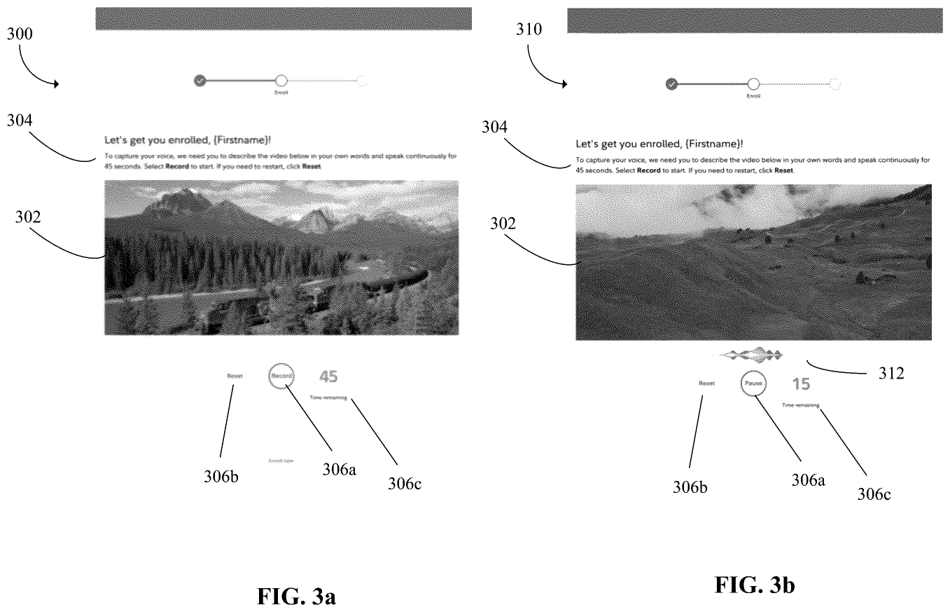

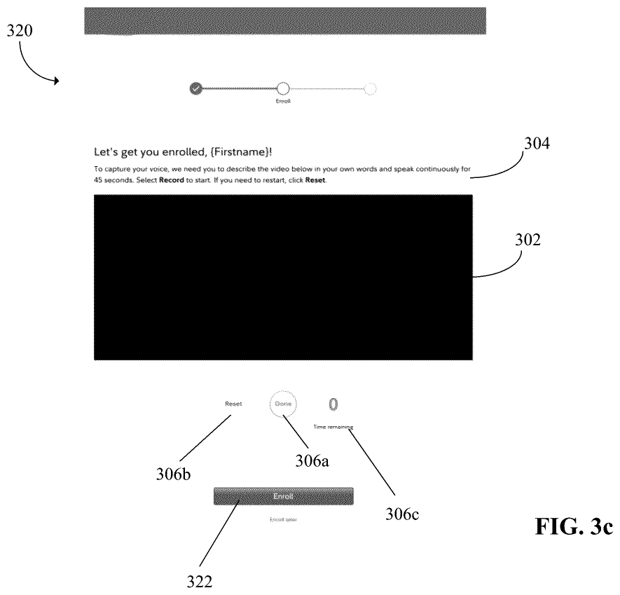

FIGS. 3a-c show a series of exemplary user interfaces for capturing an enrolling customer's thinking voice based on an exemplary personalize media clip displayed to the customer, according to some embodiments of the present invention. As shown in the user interface 300 of FIG. 3a, the enrolling customer is provided with a personalized video segment 302 containing at least one image of a train determined from the trained AI model as discussed above with reference to step 204 of method 200. More specifically, this train image is determined by the AI model as being relevant to the enrolling customer, thus providing the customer with a visual for which he/she can describe based on past knowledge and/or related experiences. The user interface 300 can further display instructions 304 to the user for recording the customer's voice sample with respect to the video segment 302. In some embodiments, the customer can record his/her voice sample after the video is played. In some embodiments, the customer is asked to record his/her voice sample as the video is being played. For example, the instructions 304 can ask the customer to vocally describe what he/she is seeing in the video segment 302 by speaking continuous for a specific period of time and select “record” to start recording or “reset” to restart recording. The recording area 306 of the user interface 300 can display a record status button 306a, a reset button 306b, and a countdown clock 306c indicating the time period left for voice recording.

The exemplary user interface 310 of FIG. 3b illustrates how an enrolling customer can record his/her voice sample. As shown, upon the customer pressing the record status button 306a, the video segment 302 starts to play. Contemporaneous with the video presentation, the customer can start to vocally describe the content of the video segment 302 as it is being played, while the digital enrollment engine 100 records the customer's utterance. While the customer is speaking, a visual que 312 can appear on the user interface 310 to confirm that audio is being heard and voice recording is in progress. Further, the countdown clock 306c can be activated to track the customer's recording progress by indicating the time remaining. In some embodiments, the record status button 306a can display a “paused” sign to allow the customer to pause the recording and/or the video presentation. As described above, the composite of images in the video segment 302 can be determined by the digital enrollment engine 100 during run time from the trained AI model and played to the enrolling customer during the recording session.

FIG. 3c shows an exemplary user interface 320 of when the recording session is completed. As shown, at the end of the recording session, the video segment 302 is no long played. In some embodiments, the record status button 306a can display a “Done” sign and the countdown clock 306c can indicate 0 seconds remaining. Further, an enrollment button 322 can appear after audio acquisition to allow the customer to actively proceed with the enrollment process. For example, upon the customer clicking the enrollment button 322, the digital enrollment engine 100 can authenticate the customer by ensuring that the recorded vocal description, which captures the context of what the customer uttered, conforms to the content of the video segment 302. Alternatively, the customer can activate the reset button 306b to repeat the recording session, at which point a new media clip can be generated and presented to the customer.

Referring back to the enrollment process 200 of FIG. 2, after an audio recording of the enrolling customer is captured by the digital enrollment engine 100, the orchestration module 116 is adapted to transmit the recording to the authentication module 118 of the digital enrollment engine 100 for authenticating the customer associated with the digital enrollment request (step 208). In some embodiments, authenticating the customer involves the authentication module 118 calculating a confidence score that generally measures a degree of accuracy between the audio description by the customer and the content of the personalized media clip. This accuracy score is adapted to validate the liveness, authenticity, and accuracy of the digital enrollment process. To calculate this score, the authentication module 118 can first process the audio recording by generating a text representation of the audio description using a speech-to-text tool, tokening the text representation and/or removing one or more stop words from the text representation. Other processing methods applied to the audio recording include audio compression and/or voice analysis to determine, for example, sentiment, background frequency, pauses, speech cadence, etc. In some embodiments, the confidence score calculated by the authentication module 118 is a weighted sum of two or more scores including a static word matching score, a dynamic text similarity matching score, a video/audio stamp matching score, a handshake model matching score, and a predictive digital fraud score. The weights assigned to these scores can be the same or different based on their relative importance in the authentication process.

The static word matching score is generated by comparing the text representation of the audio description from the enrolling customer with a list of one or more predefined keywords associated with the media clip to determine the degree at which the audio description captures these predefined keywords. The dynamic text similarity matching score is generated by comparing the text representation of the audio description with a list of one or more dynamic runtime keywords associated with the personalized media clip to determine the degree at which the audio description captures these dynamic keywords. As described above, these predefined static keywords and dynamic runtime keywords associated with the personalized media clip can be generated by the visual processing AI module 114 and stored in the database 108. The video/audio stamp matching score determines the degree with which the customer's audio description correctly captures the order of presentation of the media objects in the media clip. As described above, this order of presentation is randomized and only determined at runtime as the media clip is played to the enrolling customer. Such ad-hoc presentation ensures that the media clip is personalized and unique to the enrolling customer as it captures an appropriate amount of randomness dictated by the trained AI model. Thus the video/audio stamp matching score is adapted to validate the enrolling customer's audio description with respect to the dynamic ordering of media objects in the media clip.

The handshake model matching score indicates if the enrolling customer is a part of a digital enrollment guest list for the digital service requested. Prior to the enrolling request, the customer can be presented with a channel-agnostic invitation (via, for example, email, online account access or mobile app launch) to interact with the digital service enrollment system 100. This invitation can have an expiration time after which any interaction is considered invalid. If the customer interacts with the digital service enrollment system 100 within the set time, the system 100 can loosely validate the authenticity of the invitation. In some embodiments, the handshake model matching score is a binary score with one score indicating that the invitation is valid and another score indicating that the invitation is invalid or the customer was never a part of a digital enrollment guest list. The predictive digital fraud score can be generated based on performing fraud analytics on the enrolling customer. These fraud analytics can include a composite of external digital fraud intelligence and internal fraud analytics on the customer. For example, fraud data can be received from centralized or external fraud agencies, where the fraud data includes information rooted in (i) digital footprint of the device or the network metadata, and/or (ii) existing list of voice prints that tagged as potential fraudsters within the current agency or indicated by an external agency.

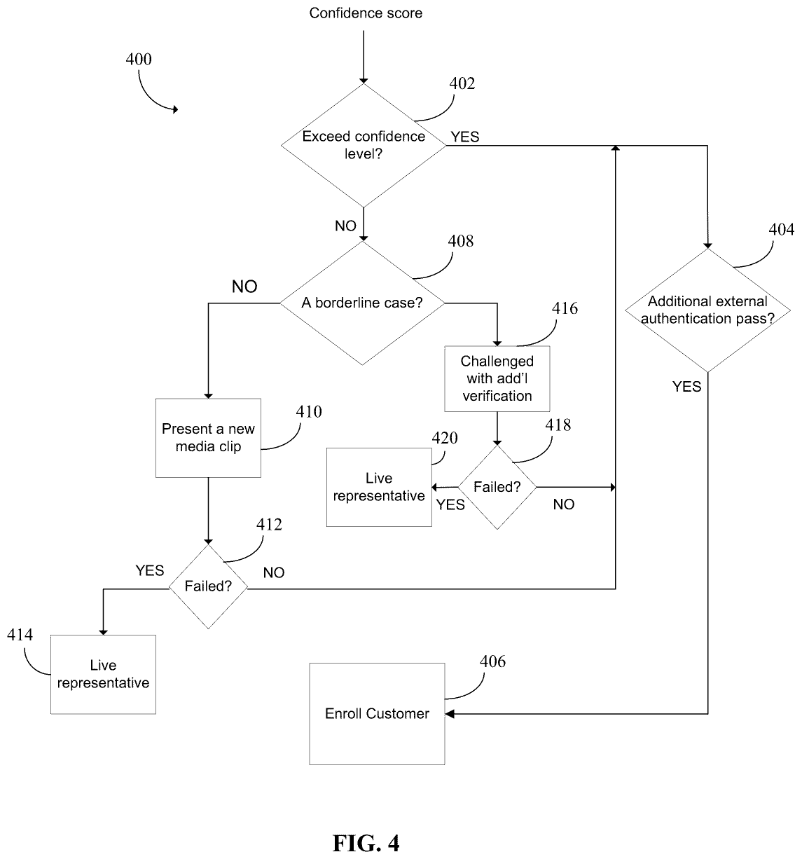

Referring back to FIG. 2, after the authentication module 118 calculates the confidence score and forwards the score to the orchestration module 116, the orchestration module 116 is configured to determine whether to enroll the customer into the digital service based on the confidence score. FIG. 4 shows an exemplary decision process employed by the orchestration module 116 of the digital enrollment engine 100 of FIG. 1 to determine whether to enroll a customer, according to some embodiments of the present invention. As shown, the confidence score is first compared with a predefined confidence level (step 402). If the confidence score exceeds the predefined confidence level, the orchestration module 118 interacts with one or more external systems (e.g., vendor systems) to perform additional types of authentication (step 404), such as biometrics validation of the customer's voice sample against a stored voice print of the customer. Other authentication techniques can include playback detection, synthetic voice detection and known fraudster list check. The customer is allowed digital service enrollment if the customer passes at least one of the additional authentication checks or the confidence score exceeds the predefined confidence level. In some embodiments, enrollment is allowed if both conditions are satisfied (step 406). In some embodiments, if the customer fails any of the authentication checks, the enrollment is considered unsuccessful, and no voice print is registered. In some embodiments, after a number of failed attempts (e.g., three failed attempts), the customer account is completely locked for enrollment.

Alternatively, if the confidence score is below the predefined confidence level, it is determined if the score is in a borderline range, such as below the confidence level but above a lower confidence threshold (step 408). If the confidence score does not represent a borderline case, the customer can be presented with a new personalized media clip by repeating steps 204-210 of process 200 of FIG. 2 (step 410). Such an attempt can be made several times. If the customer fails at the end of multiple attempts (step 412), the customer can be routed to a live representative for live enrollment processing (step 414). Otherwise process proceeds to step 404 to perform additional types of authentication. However, if the confidence level indicates a borderline scenario (step 408), the customer can be challenged with additional verification actions (step 416), such as supplying the last four digits of his/her social security number, zip code on file, beneficiaries on file, etc., without presenting a new media clip to the customer. If the customer fails these additional verification actions (step 418), the customer can be routed to a live representative for live enrollment processing (step 420). Otherwise, process proceeds to step 404 to perform additional types of authentication.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for responding to a request by a customer to enroll into a digital service, the computerized method comprising:
generating, by a computing device, a personalized media clip for presentation to the enrolling customer, generating the personalized media clip comprises (i) using an artificial intelligence (AI) model to determine a plurality of relevant media objects based on data related to the request and customer data and (ii) forming a randomized composite of the plurality of relevant media objects;
providing, by the computing device, the personalized media clip along with an instruction to the customer to record an audio description of the personalized media clip;
generating, by the computing device, a confidence score that measures a degree of accuracy of the audio description by the customer in relation to the personalized media clip, the confidence score comprises a weighted sum of a plurality of matching scores including (i) a static matching score generated by comparing a text representation of the audio description with a list of one or more predefined keywords, and (ii) an AI score generated by determining whether the text representation describes the randomized composite of the relevant media objects in the personalized media clip; and
enrolling, by the computing device, the customer into the digital service based on at least the confidence score.

2. The computerized method of claim 1, wherein each of the plurality of relevant media objects comprises one of a visual image or an audio segment.

3. The computerized method of claim 1, wherein the AI model is trained to model relationships between historical request contexts and media objects.

4. The computerized method of claim 1, wherein the data related to the request and the customer data includes one or more of customer demographics information, customer browsing history and interaction history from similar customers.

5. The computerized method of claim 1, wherein the personalized media clip comprises a video segment of a randomized composite of images selected by the AI model.

6. The computerized method of claim 1, wherein the randomized composite is formed at runtime as the personalized media clip is presented to the customer.

7. The computerized method of claim 1, wherein the instruction further includes interactive requests asking the customer for one or more physical inputs.

8. The computerized method of claim 5, wherein the one or more physical inputs include face capture, expression capture, body movements, or click or drag a visual item.

9. The computerized method of claim 1, further comprising processing the text representation of the audio description before generating the plurality of matching scores, wherein processing the text representation comprises one or more of tokening the text representation and removing one or more stop words from the text representation.

10. The computerized method of claim 1, wherein the plurality of matching scores further includes a fraud score generated based on fraud analytics of the customer.

11. The computerized method of claim 1, wherein the plurality of matching scores further includes a score indicating if the customer is a part of a digital enrollment guest list for the digital service.

12. The computerized method of claim 1, wherein the plurality of matching scores further includes a dynamic matching score generated by computing and allocating weights to words in the text representation of the audio description.

13. The computerized method of claim 1, wherein enrolling the customer based on at least the confidence score comprises:
comparing the confidence score with a predefined confidence level;
confirming that a biometric signal associated with the customer matches the customer's biometric print; and
allowing customer enrollment if at least one of the confidence score exceeds the predefined confidence level and the biometric signal matches.

14. The computerized method of claim 13, further comprising presenting the customer with a new personalized media clip if the confidence score is below the predefined confidence level but above a lower confidence threshold indicating a borderline case.

15. A computerized means for responding to a request by a customer to enroll into a digital service, the computerized means comprising:
means for generating a personalized media clip for presentation to the enrolling customer including (i) means for generating and training an artificial intelligence (AI) model to determine a plurality of relevant media objects based on data related to the request and customer data and (ii) means for forming a randomized composite of the plurality of relevant media objects;
means for providing the personalized media clip along with an instruction to the customer to record an audio description of the personalized media clip;
means for generating a confidence score that measures a degree of accuracy of the audio description by the customer in relation to the personalized media clip, the confidence score comprises a weighted sum of a plurality of matching scores including (i) a static matching score generated by comparing a text representation of the audio description with a list of one or more predefined keywords, and (ii) an AI score generated by determining whether the text representation describes the randomized composite of the relevant media objects in the personalized media clip; and
means for enrolling the customer into the digital service based on at least the confidence score.

16. The computerized means of claim 15, wherein each of the plurality of relevant media objects comprises one of a visual image or an audio segment.

17. The computerized means of claim 15, wherein the AI model is trained to model relationships between historical request contexts and media objects.

18. The computerized means of claim 15, further comprising means for processing the text representation of the audio description before generating the plurality of matching scores, wherein the means for processing the text representation comprises one or more of means for tokening the text representation and means for removing one or more stop words from the text representation.

19. The computerized means of claim 15, wherein the plurality of matching scores further includes a fraud score generated based on fraud analytics of the customer.

20. The computerized means of claim 15, wherein the plurality of matching scores further includes a score indicating if the customer is a part of a digital enrollment guest list for the digital service.
